(19) United States
(12) Patent Application Publication
(10) Pub. No.: US 2025/0108929 A1
(43) Pub. Date: Apr. 3, 2025

(54) Two Piece Nested Air Intake Scoop for Engine Cowl

(71) Applicant: The Boeing Company, Arlington, VA (US)

(72) Inventors: Michael Basala, Charleston, SC (US); Carl Allen Piland, Charleston, SC (US)

(21) Appl. No.: 18/479,334

(22) Filed: Oct. 2, 2023

(51) Int. Cl. B64D 33/02; F02B 29/04

(52) U.S. Cl. CPC B64D 33/02; F02B 29/0431; B64D 2241/00

(57) ABSTRACT

A two-piece nested air intake scoop for an engine cowl and methods of assembly and manufacture. The nested air intake scoop includes an air intake scoop lower duct and an air intake scoop upper duct coupled to the air intake scoop lower duct. The air intake scoop upper duct is reversibly nested within the air intake scoop lower duct. Reversibly nested includes at least two surfaces of the air intake scoop upper duct airtight mechanically connected to at least two surfaces of the air intake scoop lower duct.

### STATEMENT OF GOVERNMENT INTEREST

This invention was made with Government support under contract number FA8628-19-D-1000-FA810721F0008 awarded by Department of Defense. The Government has certain rights in this invention.

### BACKGROUND INFORMATION

### 1. Field

The present disclosure relates generally to aircraft, and more specifically to air intake scoops for engine cowls of aircraft.

### 2. Background

Typical air intake scoops are manufactured using welded assemblies or castings which are both costly and have quality issues. Additionally, due to the manufacturing processes, it is difficult to make changes to the surfaces due to cost and lead times.

Therefore, it would be desirable to have an air intake scoop, as well as methods of making and assembling that air intake scoop that take into account at least some of the issues discussed above, as well as other possible issues.

### SUMMARY

Utilizing a two piece nested configuration for an air intake scoop allows for different manufacturing processes to be utilized, including but not limited to machining and sheet metal formed parts. These manufacturing processes allow for quick changes to the surfaces at minimal cost and lead time.

An embodiment of the present disclosure provides a method of assembling a nested air intake scoop for an engine cowl, comprising: providing an air intake scoop lower duct; providing an air intake scoop upper duct; and nesting reversibly the air intake scoop upper duct within the air intake scoop lower duct, wherein nesting reversibly comprises airtight mechanically connecting at least two surfaces of the air intake scoop upper duct to at least two surfaces of the air intake scoop lower duct.

Another embodiment of the present disclosure provides a nested air intake scoop for an engine cowl, comprising: an air intake scoop lower duct; and an air intake scoop upper duct coupled to the air intake scoop lower duct, wherein the air intake scoop upper duct is reversibly nested within the air intake scoop lower duct, and wherein reversibly nested comprises at least two surfaces of the air intake scoop upper duct airtight mechanically connected to at least two surfaces of the air intake scoop lower duct.

Yet another embodiment of the present disclosure provides a method of making a nested air intake scoop for an engine cowl, comprising: fabricating an air intake scoop lower duct; fabricating an air intake scoop upper duct; and nesting reversibly the air intake scoop upper duct within the air intake scoop lower duct, wherein nesting reversibly comprises airtight mechanically connecting at least two surfaces of the air intake scoop upper duct to at least two surfaces of the air intake scoop lower duct.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of an aircraft including a two piece nested air intake scoop for an engine cowl in accordance with an illustrative embodiment;

FIG. 2A is an illustration of an exterior of an engine cowl including 2 two piece nested air intake scoops in accordance with an illustrative embodiment;

FIG. 2B is an illustration of an interior of an engine cowl including 2 two piece nested air intake scoops in accordance with an illustrative embodiment;

FIG. 2C is an illustration of a portion of an interior of an engine cowl including a two piece nested air intake scoop mounted on an engine cowl in accordance with an illustrative embodiment;

FIG. 3A is an illustration of an exterior aspect of a two piece nested air intake scoop in accordance with an illustrative embodiment;

FIG. 3B is an illustration of an exterior aspect of an air intake scoop upper duct of the two piece nested air intake scoop shown in FIG. 3A in accordance with an illustrative embodiment;

FIG. 3C is an illustration of an interior aspect of a two piece nested air intake scoop in accordance with an illustrative embodiment;

FIG. 3D is an illustration of an exterior aspect of an air intake scoop lower duct of the two piece nested air intake scoop shown in FIG. 3C in accordance with an illustrative embodiment;

FIG. 4A is an illustration of a cross section of a two piece nested air intake scoop in accordance with an illustrative embodiment;

FIG. 4B is an illustration of a cross section of a two piece nested air intake scoop in accordance with an illustrative embodiment;

FIG. 5 is an illustration of a cross section of a two piece nested air intake scoop in accordance with an illustrative embodiment;

FIG. 6 is an illustration of a cross section of a two piece nested air intake scoop in accordance with an illustrative embodiment;

FIG. 7 is a flowchart of a method of assembling a nested air intake scoop for an engine cowl in accordance with an illustrative embodiment;

FIG. 8 is a flowchart of a method of making a nested air intake scoop for an engine cowl in accordance with an illustrative embodiment;

FIG. 9 is an illustration of an aircraft manufacturing and service method in a form of a block diagram in accordance with an illustrative embodiment; and

FIG. 10 is an illustration of an aircraft in a form of a block diagram in which an illustrative embodiment may be implemented.

### DETAILED DESCRIPTION

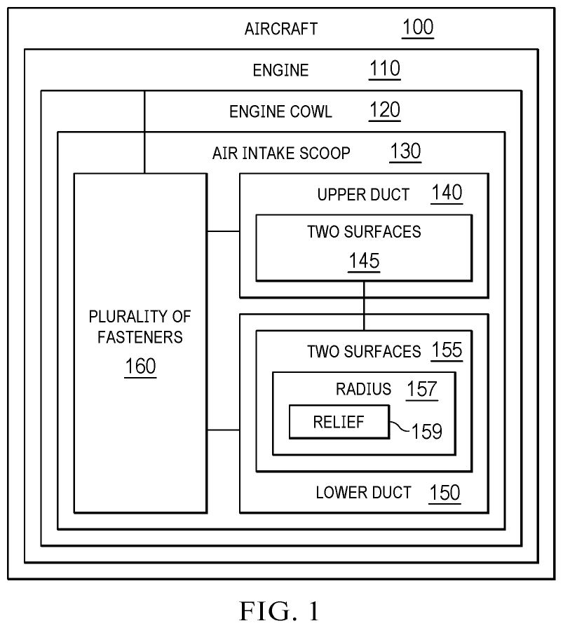

Turning now to FIG. 1, an illustration of a block diagram of an aircraft 100 with an engine 110 is depicted in accordance with an illustrative embodiment. The engine 110 includes an engine cowl 120.

A two piece nested air intake scoop 130 is coupled to the engine cowl 120. The two piece nested air intake scoop 130 can be coupled to an interior surface of the cowl 120.

The two piece nested air intake scoop 130 includes an air intake scoop upper duct 140 and an air intake scoop lower duct 150. The air intake scoop lower duct 150 is coupled to the air intake scoop upper duct 140. The air intake scoop lower duct 150 can be coupled to the air intake scoop upper duct 140 with a plurality of fasteners 160. Coupled is intended to mean connected although not necessarily directly connected. The fasteners 160 can extend into engine cowl 120, thereby coupling the two piece nested air intake scoop 130 to the engine cowl 120. The plurality of fasteners 160 can be removable fasteners.

An important aspect of embodiments of this disclosure is that the air intake scoop upper duct 140 is nested within the air intake scoop lower duct 150. Nested is intended to mean that at least two surfaces 145 of the air intake scoop upper duct 140 are airtight mechanically connected to at least two surfaces 155 of the air intake scoop lower duct 150, although not necessarily directly.

The air intake scoop upper duct 140 can be reversibly nested within the air intake scoop lower duct 150. Reversibly nested is intended to mean that the nesting can be completed, then undone and optionally completed again and then undone again, potentially multiple times. Reversibly nested enables quick changes to surfaces of the air intake scoop upper duct 140 and the air intake scoop lower duct 150 at minimal cost and lead time. The changes can be to one some or all of the surfaces of the air intake scoop upper duct 140 and the air intake scoop lower duct 150. These surfaces being changed may or may not include the at least two surfaces 145 of the air intake scoop upper duct 140 are airtight mechanically connected to at least two surfaces 155 of the air intake scoop lower duct 150.

The air intake scoop lower duct 150 can include a radius 157 on at least one interior edge of the air intake scoop lower duct 150. The air intake scoop lower duct 150 can include a bullnose radius on at least one interior edge of the air intake scoop lower duct. The (bullnose) radius can be a result of forming the air intake scoop lower duct, for example sheet metal fabrication.

The nested air intake scoop lower duct can include a relief 159 on at least one interior edge of the air intake scoop lower duct 150. The nested air intake scoop lower duct can include a chamfer relief on at least one interior edge of the air intake scoop lower duct. The (chamfer) relief can be cut or formed over the (bullnose) radius to provide clearance so that the at least two surfaces 145 of the air intake scoop upper duct 140 are airtight mechanically connected to at least two surfaces 155 of the air intake scoop lower duct 150.

Embodiments of this disclosure can include coupling the two piece nested air intake scoop 130 to the engine cowl 120. Embodiments of this disclosure can include coupling the engine cowl 120 to the engine 110. Embodiments of this disclosure can include coupling the engine 110 to the aircraft 100.

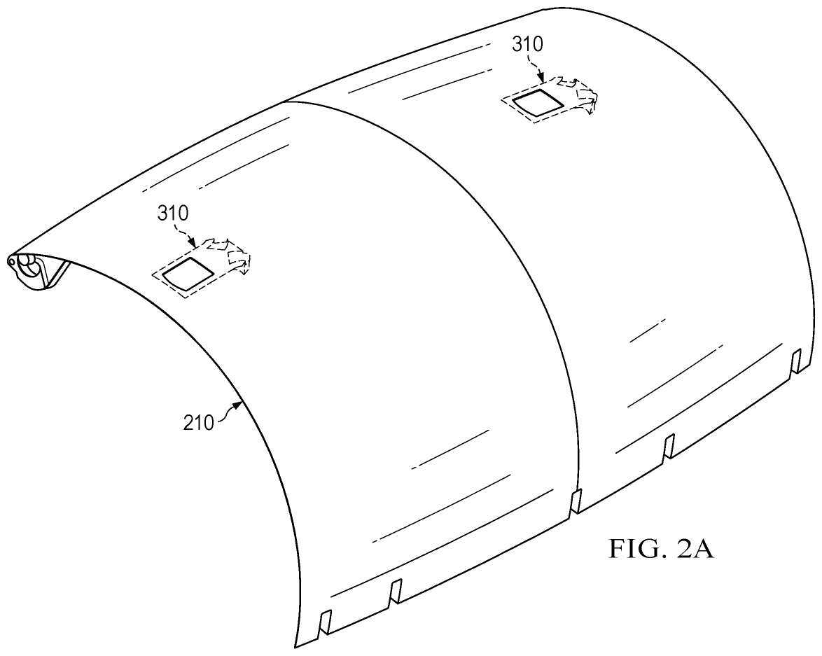

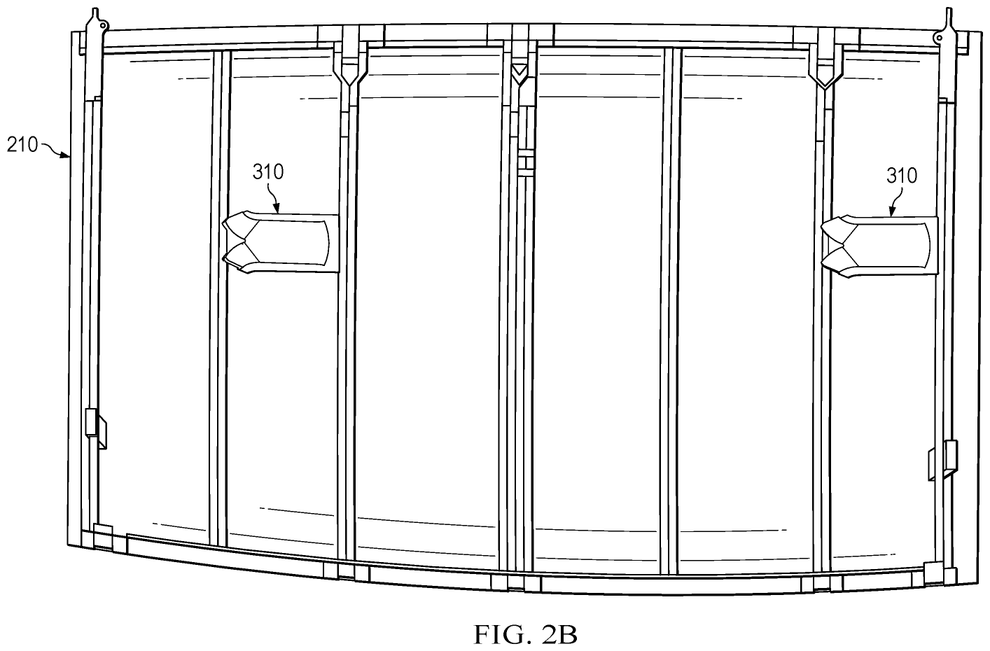

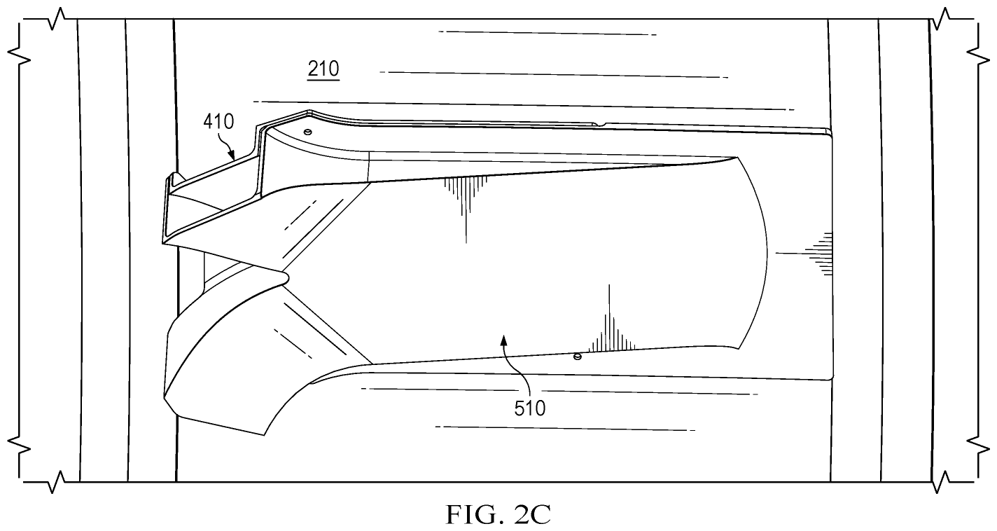

Turning to FIG. 2A, cowl 210 is a physical implementation of cowl 120 of FIG. 1. Cowl 210 includes 2 installed implementations of two piece nested air intake scoop 310. Two piece nested air intake scoop 310 is a physical implementation of two piece nested air intake 130 of FIG. 1.

Turning to FIG. 2B, an interior view of the cowl 210 shows both of the 2 installed implementations of two piece nested air intake scoop 310. Each of the two piece nested air intake scoop 310 is located between 2 circumferential stiffeners.

Turning to FIG. 2C, each of the two piece nested air intake scoops includes an air intake scoop upper duct 410 and an air intake scoop lower duct 510.

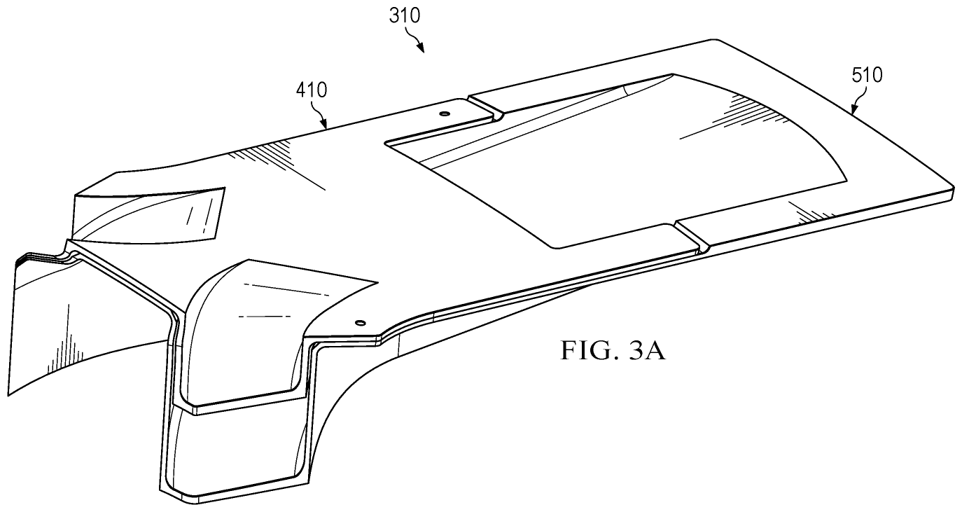

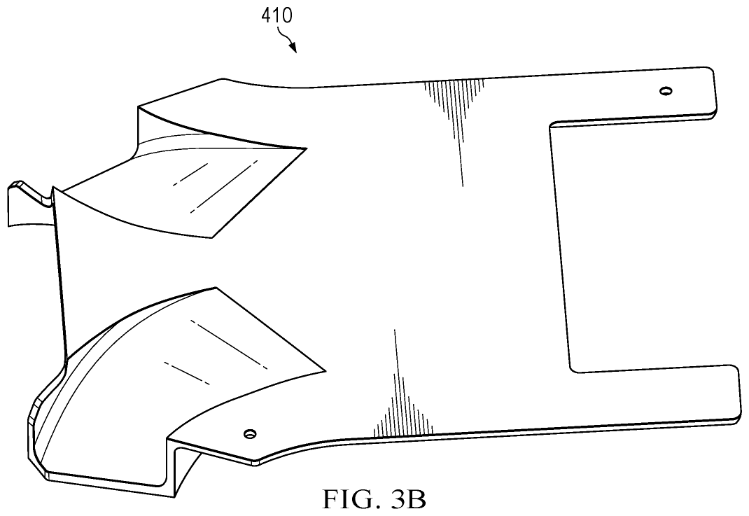

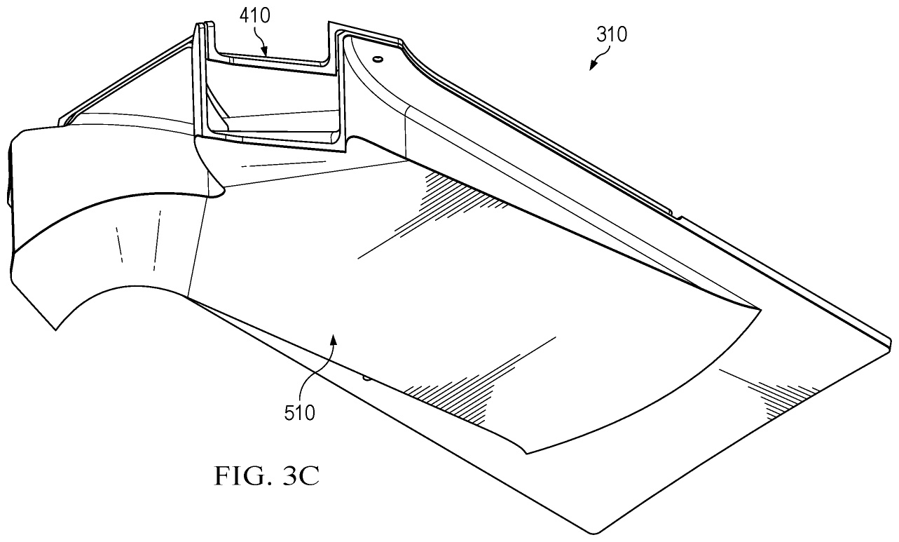

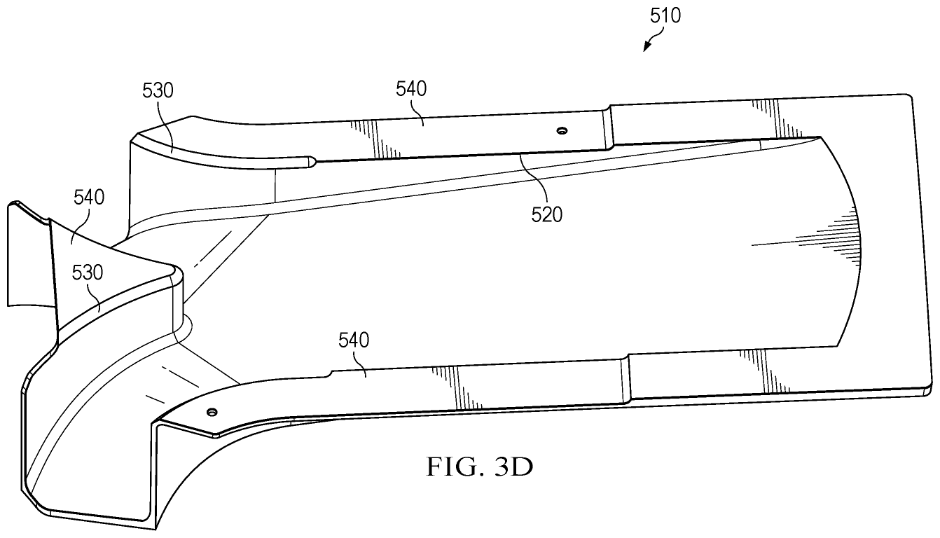

Turning to FIG. 3A, the two piece nested air intake scoop 310 includes air intake scoop upper duct 410 nested with air intake scoop lower duct 510. The air intake scoop upper duct 410 can be reversibly nested within the air intake scoop lower duct 510. In this view, 2 holes for 2 removable fasteners can be seen. Of course, embodiments of this disclosure are not limited to 2 holes for 2 fasteners, removable or otherwise. Embodiments of this disclosure can include 1, 2, 3, 4, 5, 6 or more holes for fasteners.

Turning to FIG. 3B, the air intake scoop upper duct 410 includes at least two surfaces (not shown in FIG. 3B) for airtight mechanically connecting to at least two surfaces of the air intake scoop lower duct. In this view, the 2 holes for 2 removable fasteners can be seen.

Turning to FIG. 3C, nesting reversibly the air intake scoop upper duct 410 within the air intake scoop lower duct 510 includes airtight mechanically connecting at least two surfaces of the air intake scoop upper duct to at least two surfaces of the air intake scoop lower duct, (not shown in FIG. 3C). In this view, only 1 hole for 1 removable fastener can be seen.

Turning to FIG. 3D, the air intake scoop lower duct 510 includes at least two surfaces 540 for airtight mechanically connecting to at least two surfaces of the air intake scoop upper duct. Radius 520 is partially relieved with chamfer 530. In this embodiment, there are three surfaces 540 for airtight mechanically connecting to at least two surfaces of the air intake scoop upper duct 410. Of course, embodiments of this disclosure are not limited to pairs of two surfaces or pairs of three surfaces for airtight mechanically connecting. Embodiments of this disclosure can include 1, 2, 3, 4 or more pairs of surfaces for airtight mechanically connecting. Again, the 2 holes for 2 removable fasteners can be seen.

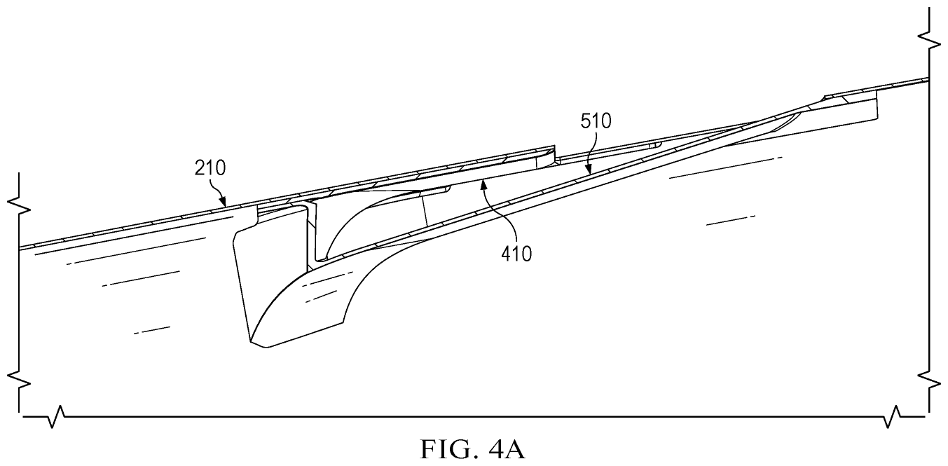

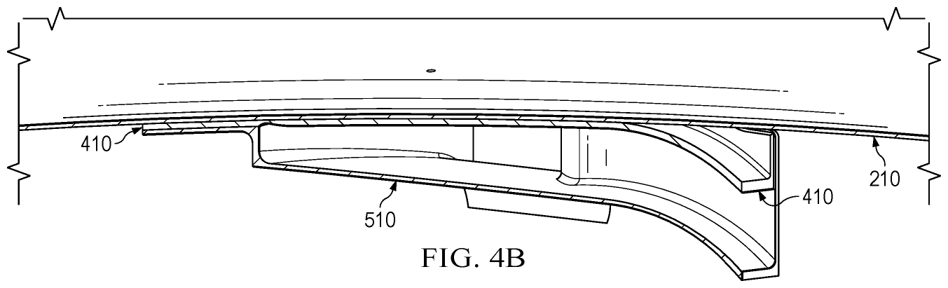

Turning to FIG. 4A, it can be appreciated from this section view that air intake scoop upper duct 410 is nested with air intake scoop lower duct 510. It can also be appreciated from this view that the nested surfaces are substantially flat, coextensive and provide an airtight mechanical connection. Air intake scoop upper duct 410 and air intake scoop lower duct 510 are both connected to an interior surface of the engine cowl 210.

Turning to FIG. 4B, again in this sectional view air intake scoop upper duct 410 is nested with air intake scoop lower duct 510. The nested surfaces are substantially flat, coextensive and provide an airtight mechanical connection. Air intake scoop upper duct 410 and air intake scoop lower duct 510 are connected to an interior surface of the engine cowl 210.

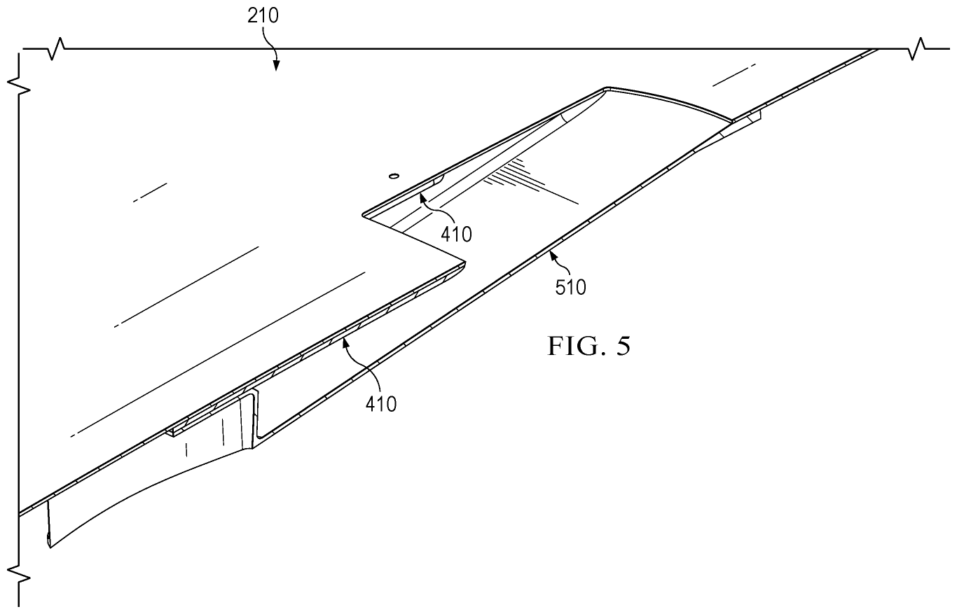

Turning to FIG. 5, air intake scoop upper duct 410 is nested with air intake scoop lower duct 510. The nested surfaces are substantially flat, coextensive and provide an airtight mechanical connection. In this view, 1 hole for 1 removable fastener can be seen. Air intake scoop upper duct 410 and air intake scoop lower duct 510 are connected to an interior surface of the engine cowl 210.

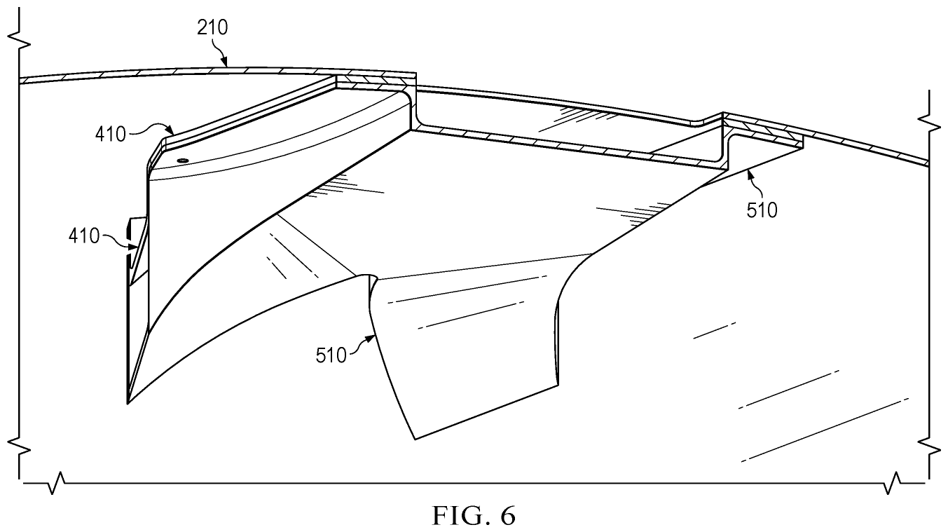

Turning to FIG. 6, air intake scoop upper duct 410 is nested with air intake scoop lower duct 510. The nested surfaces are substantially flat, coextensive and provide an airtight mechanical connection. In this view, 1 hole for 1 removable fastener can be seen. Air intake scoop upper duct 410 and air intake scoop lower duct 510 are connected to an interior surface of the engine cowl 210.

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required. As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional.

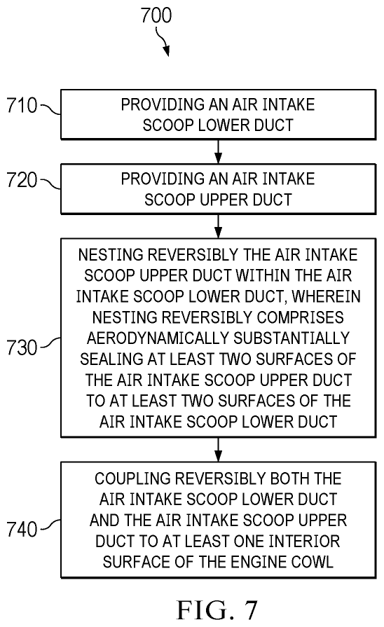

Turning to FIG. 7, an embodiment of this description can include a method of assembling a nested air intake scoop for an engine cowl 700. Block 710 includes providing an air intake scoop lower duct. Block 720 includes providing an air intake scoop upper duct. Block 730 includes nesting reversibly the air intake scoop upper duct within the air intake scoop lower duct. In this embodiment, nesting reversibly can include airtight mechanically connecting at least two surfaces of the air intake scoop upper duct to at least two surfaces of the air intake scoop lower duct. In this embodiment, block 740 is optional and includes coupling reversibly both the air intake scoop lower duct and the air intake scoop upper duct to at least one interior surface of the engine cowl.

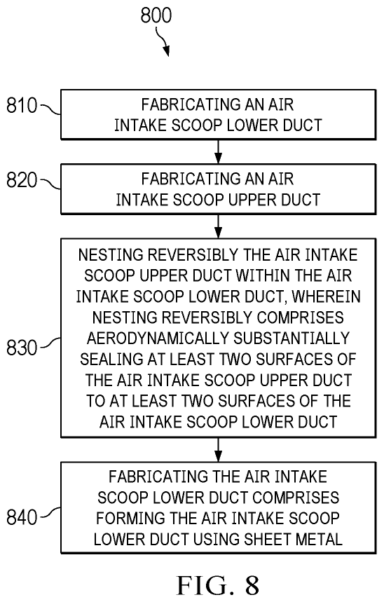

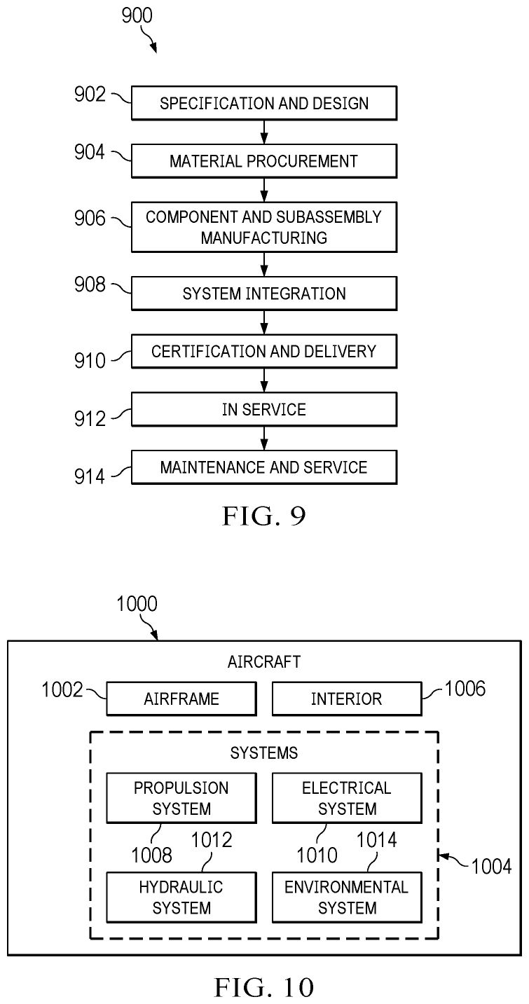

Turning to FIG. 8, an embodiment of this specification can include a method of making a nested air intake scoop for an engine cowl 800. Block 810 includes fabricating an air intake scoop lower duct. Block 820 includes fabricating an air intake scoop upper duct. Block 830 includes nesting reversibly the air intake scoop upper duct within the air intake scoop lower duct. In this embodiment, nesting reversibly comprises airtight mechanically connecting at least two surfaces of the air intake scoop upper duct to at least two surfaces of the air intake scoop lower duct. In this embodiment, block 840 is optional and includes fabricating the air intake scoop lower duct comprises forming the air intake scoop lower duct using sheet metal.

Illustrative embodiments of the present disclosure may be described in the context of aircraft manufacturing and service method 1800 as shown in FIG. 18 and aircraft 1900 as shown in FIG. 19. Turning first to FIG. 18, an illustration of an aircraft manufacturing and service method in the form of a block diagram is depicted in accordance with an illustrative embodiment. During pre-production, aircraft manufacturing and service method 1800 may include specification and design 1802 of aircraft 1900 in FIG. 19 and material procurement 1804.

During production, component and subassembly manufacturing 1806 and system integration 1808 of aircraft 1900 takes place. Thereafter, aircraft 1900 may go through certification and delivery 1810 in order to be placed in service 1812. While in service 1812 by a customer, aircraft 1900 is scheduled for routine maintenance and service 1814, which may include modification, reconfiguration, refurbishment, or other maintenance and service.

Each of the processes of aircraft manufacturing and service method 1800 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 19, an illustration of an aircraft in a form of a block diagram is depicted in which an illustrative embodiment may be implemented. In this example, aircraft 1900 is produced by aircraft manufacturing and service method 1800 of FIG. 18 and may include airframe 1902 with plurality of systems 1904 and interior 1906. Examples of systems 1904 include one or more of propulsion system 1908, electrical system 1910, hydraulic system 1912, and environmental system 1914. Any number of other systems may be included.

Apparatuses and methods embodied herein may be employed during at least one of the stages of aircraft manufacturing and service method 1800. One or more illustrative embodiments may be manufactured or used during at least one of component and subassembly manufacturing 1806, system integration 1808, in service 1812, or maintenance and service 1814 of FIG. 18.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method of assembling a nested air intake scoop for an engine cowl, comprising:
providing an air intake scoop lower duct;
providing an air intake scoop upper duct; and
nesting reversibly the air intake scoop upper duct within the air intake scoop lower duct,
wherein nesting reversibly comprises airtight mechanically connecting at least two surfaces of the air intake scoop upper duct to at least two surfaces of the air intake scoop lower duct.

2. The method of claim 1, further comprising coupling reversibly both the air intake scoop lower duct and the air intake scoop upper duct to at least one interior surface of the engine cowl.

3. The method of claim 2, wherein coupling reversibly both the air intake scoop lower duct and the air intake scoop upper duct to the at least one interior surface of the engine cowl comprises coupling reversibly both the air intake scoop lower duct and the air intake scoop upper duct to the at least one interior surface of the engine cowl using a plurality of fasteners.

4. The method of claim 3, wherein each of the plurality of fasteners comprise a removable fastener.

5. The method of claim 4, further comprising
removing the plurality of removable fasteners; and
removing both the air intake scoop lower duct and the air intake scoop upper duct from the engine cowl.

6. The method of claim 5, further comprising, after removing, separating the air intake scoop upper duct from the air intake scoop lower duct.

7. The method of claim 6, further comprising, after separating, coating at least one surface of the air intake scoop lower duct or at least one surface of the air intake scoop upper duct.

8. The method of claim 7, further comprising, before coating, stripping a coating from at least one surface of the air intake scoop lower duct or at least one surface of the air intake scoop upper duct.

9. The method of claim 6, further comprising, after separating, coating at least one surface of the air intake scoop lower duct and at least one surface of the air intake scoop upper duct.

10. The method of claim 9, further comprising, before coating, stripping a coating from at least one surface of the air intake scoop lower duct and at least one surface of the air intake scoop upper duct.

11. A nested air intake scoop for an engine cowl, comprising:
an air intake scoop lower duct; and
an air intake scoop upper duct coupled to the air intake scoop lower duct,
wherein the air intake scoop upper duct is reversibly nested within the air intake scoop lower duct, and
wherein reversibly nested comprises at least two surfaces of the air intake scoop upper duct airtight mechanically connected to at least two surfaces of the air intake scoop lower duct.

12. The nested air intake scoop of claim 11, further comprising a plurality of fasteners, each of the plurality of fasteners coupled to both the air intake scoop lower duct and the air intake scoop upper duct.

13. The nested air intake scoop of claim 12, wherein each of the plurality of fasteners comprise a removable fastener.

14. The nested air intake scoop of claim 11, wherein the air intake scoop lower duct comprises a bullnose radius on at least one interior edge of the air intake scoop lower duct.

15. The nested air intake scoop of claim 11, wherein the air intake scoop lower duct comprises a chamfer relief on at least one interior edge of the air intake scoop lower duct.

16. The nested air intake scoop of claim 11, further comprising the engine cowl.

17. A method of making a nested air intake scoop for an engine cowl, comprising:
fabricating an air intake scoop lower duct;
fabricating an air intake scoop upper duct; and
nesting reversibly the air intake scoop upper duct within the air intake scoop lower duct,
wherein nesting reversibly comprises airtight mechanically connecting at least two surfaces of the air intake scoop upper duct to at least two surfaces of the air intake scoop lower duct.

18. The method of claim 17, wherein fabricating the air intake scoop lower duct comprises forming the air intake scoop lower duct using sheet metal.

19. The method of claim 17, wherein fabricating the air intake scoop lower duct comprises 3D printing the air intake scoop lower duct using at least one thermoplastic polymer.

20. The method of claim 17, wherein fabricating the air intake scoop lower duct comprises machining the air intake scoop lower duct using at least one solid blank.

21. The method of claim 17, wherein fabricating the air intake scoop lower duct comprises casting the air intake scoop lower duct using a metal alloy.

22. The method of claim 17, wherein fabricating the air intake scoop upper duct comprises forming the air intake scoop upper duct using sheet metal.

23. The method of claim 17, wherein fabricating the air intake scoop upper duct comprises 3D printing the air intake scoop upper duct using at least one thermoplastic polymer.

24. The method of claim 17, wherein fabricating the air intake scoop upper duct comprises machining the air intake scoop upper duct using at least one solid blank.

25. The method of claim 17, wherein fabricating the air intake scoop upper duct comprises casting the air intake scoop upper duct using a metal alloy.
